(19) United States
(12) Patent Application Publication
(10) Pub. No.: US 2022/0097971 A1
(43) Pub. Date: Mar. 31, 2022

(54) SMART VENDING MACHINES FOR FISHING TACKLE AND METHOD OF DISTRIBUTING THE SAME

(71) Applicant: Daniel C. Orefice, Somers, CT (US)

(72) Inventor: Daniel C. Orefice, Somers, CT (US)

(21) Appl. No.: 17/449,129

(22) Filed: Sep. 28, 2021

Related U.S. Application Data
(60) Provisional application No. 63/198,138, filed on Sep. 30, 2020.

(51) Int. Cl. B65G 1/137; G07F 17/00; G06Q 20/18; G06F 3/0488; H04L 29/08

(52) U.S. Cl. CPC B65G 1/1371; G07F 17/0014; H04L 67/12; G06F 3/0488; G06Q 20/18

(57) ABSTRACT

A tackle vending machine for distributing fishing tackle and supplies. The invention improves the traditional retail and e-commerce sites because it gives customers access to fishing products 24 hours/day and 7 days/week. Using smart technology, customers can see the different locations of the tackle vending machines, can access inventory of each vending machine, and can purchase the products either at the vending machine or online to pick up at the vending machine. The system utilizes data collected to see which products sell better in different geographic regions, times of year, and conditions to better stock the smart vending machines to give a better customer experience. Customers will also be able to make suggestions for certain products to be stocked at certain vending machine locations through our website further enhancing the customer experience.

### CROSS-REFERENCE TO RELATED APPLICATION

This application claims the benefit of priority of U.S. provisional application No. 63/198,138 filed Sep. 30, 2020, the contents of which are herein incorporated by reference.

### BACKGROUND OF THE INVENTION

The present invention relates fishing tackle, and more particularly to apparatus and methods of distributing the same.

Many anglers experience the problem of not being able to buy and receive fishing tackle, fishing supplies, or fishing gear when needed when locating tackle through traditional retail stores or e-commerce websites. Retail businesses have limited hours and online e-commerce stores have lead times and ship times.

Retail business selling fishing tackle have certain hours and most are not open 24 hours/day. These retail outlets also have high overhead and typically operate out of one or more geographically discrete locations. As such their geographic reach, or access by the angler in need, is limited. By contrast, traditional online e-commerce sites do not have a physical presence and their merchandise must be shipped to the location designated by the angler.

For the angler in immediate need of fishing tackle conventional commerce vehicles are unable to meet these needs.

As can be seen, there is a need for improved methods, and apparatus for distributing fishing tackle that is geographically proximate to the angler in need of tackle and is available on a 24-hour basis.

### SUMMARY OF THE INVENTION

In one aspect of the present invention, a fishing tackle vending machine is disclosed. The fishing tackle vending machine includes a vending machine containing a plurality of tackle items. A touchscreen display configured for a user selection of one or more of the plurality of tackle items contained within the vending machine. A payment processing module is configured to receive a payment for the one or more selected tackle items. A dispensing module is configured to vend a selected item of tackle from the plurality of tackle items for retrieval by the user. A network communications module is configured for communication with a server, the server configured to serve web pages presenting an inventory of the plurality of tackle items currently available in the vending machine and a geographic location of the vending machine.

In some embodiments, the touchscreen display is configured for receiving a query of the plurality of tackle items based on one or more of a size of the plurality of tackle items, an application of one or more of the plurality of tackle items, and a targeted game fish species of one or more of the plurality of tackle items.

In some embodiments, a temperature control is provided to maintain at least one of the plurality of tackle items at a desired temperature.

In other embodiments, a plurality of vending machines configured to share one or more of the touch screen display, the payment processing module, and the network communications module.

In other aspects of the invention, a system for dispensing fishing tackle is disclosed. The system includes a plurality of tackle vending machines each containing an inventory of a plurality of tackle items. The plurality of tackle vending machines are coupled to a server via a communications network. The inventory of the plurality of tackle items is communicated to the server via the communications network. The server hosts web pages to service the plurality of tackle vending machines, the server having at least one processor and at least one memory including computer program code, the at least one memory and the computer program code configured to, with the at least one processor, cause the server to at least provide, to a display of an angler's computing device, a first user interface configured to present of a geographic location for one or more of the plurality of tackle vending machines based on a geographic location of the angler's computing device.

In some embodiments, the server instructions, provide, to the display of the angler's computing device, a second user interface that is configured to receive an angler's query for a desired tackle item. The angler's query is received at the server via the communications network. When the desired tackle item is present in the inventory, the instructions are provide, to the display of the angler's computing device, a geographic location of one or more of the plurality of tackle vending machines containing the desired tackle item.

In some embodiments, the computer program code provides, to the display of the angler's computing device, a browser user interface configured to permit the angler to browse the inventory of the one or more of the plurality of tackle vending machines.

In other embodiments, a tackle selection from the inventory is received at the server.

In other embodiments, a payment for the tackle selection is received at the server.

In yet other embodiments, an angler purchase of the tackle selection is communicated to a designated tackle vending machine. The tackle selection is then dispensed to the angler, via a dispensing module.

These and other features, aspects and advantages of the present invention will become better understood with reference to the following drawings, description and claims.

### BRIEF DESCRIPTION OF THE DRAWINGS

FIG. 1 is a schematic view of the tackle vending machine;

FIG. 2A is a flow chart of the tackle vending system process;

FIG. 2B is a flow chart of other tackle vending system processes;

FIG. 2C is a flow chart of other tackle vending system processes;

FIG. 2D is a flow chart of other tackle vending system processes;

FIG. 2E is a flow chart of yet other tackle vending system processes; and

FIG. 3 is a schematic view of a system architecture for a tackle vending system.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, apparatus, and computer program product for distributing fishing tackle that is geographically proximate to the angler in need of tackle and is available on a 24-hour basis.

The present invention improves the traditional retail and e-commerce sites because it gives customers access to fishing tackle 24 hours/day and 7 days/week. Using smart technology, anglers can identify the different locations of the vending machines, they can access inventory of each vending machine, and they can purchase the products either at the vending machine or online to pick up at the vending machine.

The system may also use data collected through tackle transactions to determine which products sell better in specific geographic regions, times of year, and atmospheric and weather conditions to better stock the smart vending machines to give a better customer experience. Customers will also be able to make suggestions for certain products to be stocked at certain vending machine locations through our website further enhancing the customer experience.

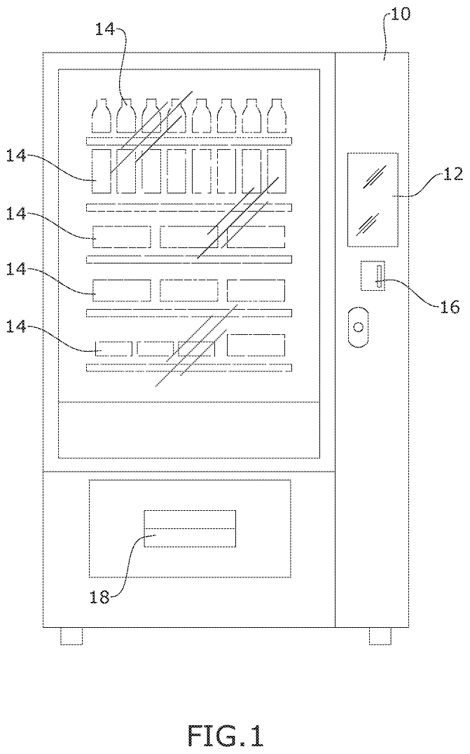

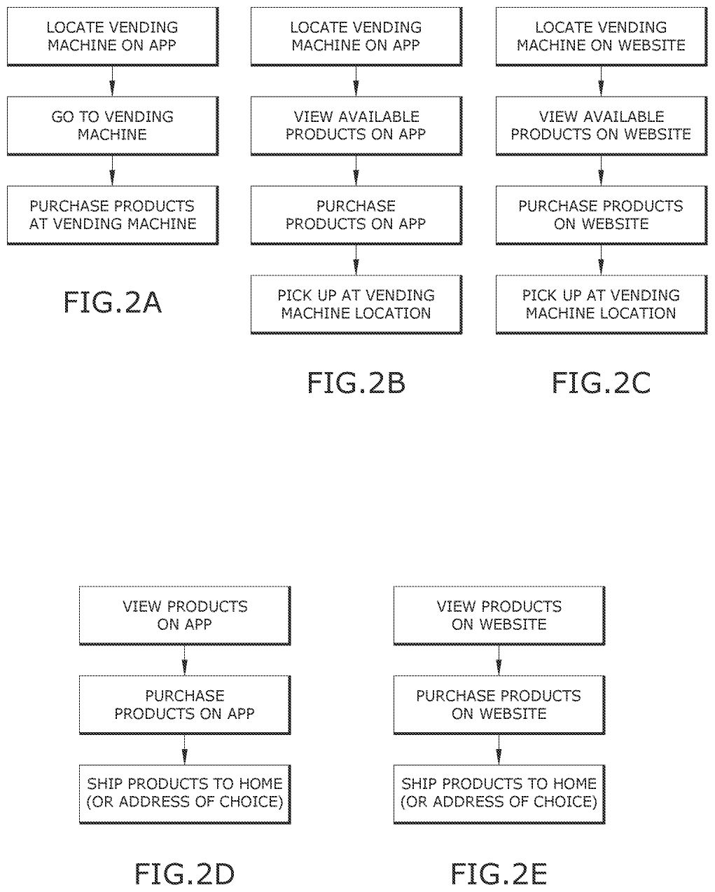

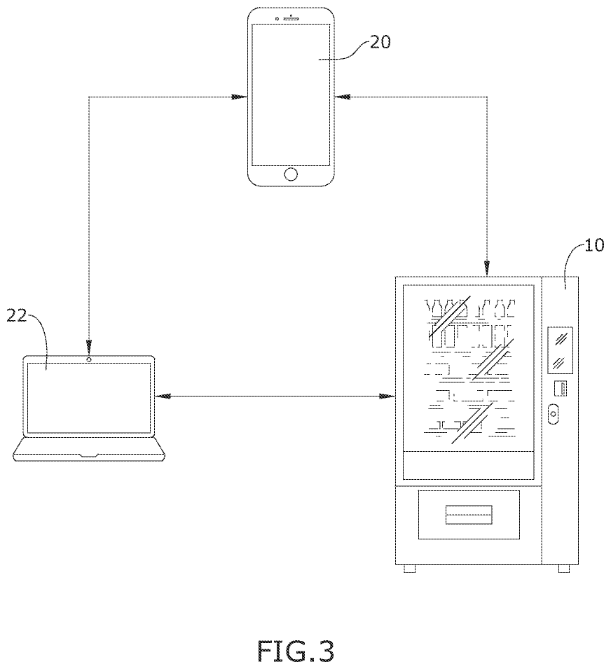

A representative tackle vending machine is shown in reference to FIG. 1. The vending machine 10 is configured to carry a plurality of tackle items 14 and may also contain a variety of beverage or food items for the angler. The vending machine 10 includes a display 12 and an interface to allow the angler to search for and identify products presently available in the vending machine 10. The items 14 may be located based on a query, such as a size of the tackle, an application of the tackle; a cost; a targeted game fish species; and other variables. The vending machine 10 may configure to accept a plurality of payment methods including cash and coins; credit cards; and a payment app.

Depending on tackle 14 carried in the vending machine 10, the vending machine 10 may be provided with a temperature control system to maintain tackle items, such as a live bait, at a desired temperature.

The venting machine 10 may be of a modular construction, with a tackle inventory 14 and dispensing module 18 and an order and payment module 16. A plurality of inventory 14 and dispensing modules 16 may be combined with a single order and payment module 16 to expand the capacity of a vending machine 10 at a given geographic location, The order and payment module 16 is configured to communicate with each of the plurality of inventory and dispensing modules to collect and distribute data regarding the current inventory and information pertaining to each item of tackle 14 in the inventory.

The order and payment module is also configured to communicate with a central server 22 to enable the tackle vending machine retailer to stock tackle 14 in the vending machines 10 that cater to a specific geographic location and communicate data collection based on real-time information to ensure products are available and stocked in the vending machines 10 that are most popular for that geographic location, fishing season, or both.

The tackle vending machine 10 is the physical aspect in this invention. The tackle vending machine 10 is where the tackle 14 is stocked, sold, and picked up. The tackle vending machine 10 could stand alone and produce sales on its own, but the tackle vending machine 10 works best when combined with a website. The website provides a virtual experience in the operation. It is the website where a customer can find locations of vending machines 10, view tackle inventory 14 in each vending machine 10, and purchase products to be picked up at a vending machine 10.

The tackle vending machine 10 and the website work best when used together to provide an enhanced customer experience that is not restricted by certain “open hours” or by lead times and shipping time. Data collection and analysis software ties both the tackle vending machine 10 and the website together and makes everything smarter, allowing the company to better learn buying patterns, stock levels, consumer demand, volume purchases, and additional data and metrics that will allow the operator to forecast and better service customers, giving a better overall customer experience.

Because we are using “smart vending technology”, consumers will be able to access the tackle 14 in the vending machines in different ways. 1.) The angler may physically go to a vending machine 10 location and see what is stocked and available at the vending machine 10; 2.) go to the website (via desktop 22 or a mobile app 20 and view available inventory in each vending machine; 3) physically go to a tackle vending machine 10 that has the product 14 available and purchase desired tackle items 14 from the vending machine 10, or 4) order the desired tackle item(s) 14 through the website and then pickup items at the correct vending machine 10 based on a user selection based on a geographic proximity to the angler.

The system may also supplement the tackle vending machines 10 with a traditional online e-commerce site. The e-commerce site allows anglers to locate tackle items 14 that are not stocked in the vending machines 10 and for those customers that do not mind waiting for tradition shipping or are not physically located close to a tackle vending machine 10.

The smart vending machine 10 and the website can be used separately, but they provide the best customer experience when used together. Customers can easily locate vending machines 10, see available inventory 14 in each vending machine 10, and purchase desired tackle products 14 (online or at the vending machine location) without relying on a retail store's open business hours or waiting the ship times from a traditional e-commerce site. If an item is listed as available on the website, then the customer can proceed to purchase the item and pick it up at the designated vending machine 10.

By utilizing the website (via desktop or mobile app) the angler can view available inventory in each vending machine 10 by geographic location. The customer will be able to see what is stocked and available at the vending machine 10. The customer will also be able to search for products based on different categories: type of product, price, size, color, species targeted, location, etc. Once the customer finds the product(s) they would like to buy, they can either:

2a) Physically go to vending machine 10 that has the tackle product 14 available and purchase desired items from the vending machine 10, or

2b.) Order the desired tackle item(s) 14 through our website and then pickup items at the correct vending machine 10.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A fishing tackle vending machine, comprising:
a vending machine containing a plurality of tackle items;
a touchscreen display configured for a user selection of one or more of the plurality of tackle items contained within the vending machine;
a payment processing module configured to receive a payment for one or more selected tackle items;
a dispensing module configured to vend a selected item of tackle from the plurality of tackle items for retrieval by the user; and
a network communications module configured for communication with a server, the server configured to serve web pages presenting an inventory of the plurality of tackle items currently available in the vending machine and a geographic location of the vending machine.

2. The fishing tackle vending machine of claim 1, wherein the touchscreen display is configured for receiving a query of the plurality of tackle items based on one or more of a size of the plurality of tackle items, an application of one or more of the plurality of tackle items, and a targeted game fish species of one or more of the plurality of tackle items.

3. The fishing tackle vending machine of claim 2, further comprising:
a temperature control to maintain at least one of the plurality of tackle items at a desired temperature.

4. The fishing tackle vending machine of claim 1, further comprising:
a plurality of vending machines configured to share one or more of the touch screen display, the payment processing module, and the network communications module.

5. A system for dispensing fishing tackle, comprising:
a plurality of tackle vending machines each containing an inventory of a plurality of tackle items, the plurality of tackle vending machines coupled to a server via a communications network, wherein the inventory of the plurality of tackle items is communicated to the server via the communications network;
the server hosting web pages to service the plurality of tackle vending machines, the server having at least one processor and at least one memory including computer program code, the at least one memory and the computer program code configured to, with the at least one processor, cause the server to at least:
provide, to a display of an angler's computing device, a first user interface configured to present of a geographic location for one or more of the plurality of tackle vending machines based on a geographic location of the angler's computing device.

6. The system of claim 5, further comprising:
provide, to the display of the angler's computing device, a second user interface configured to receive an angler's query for a desired tackle item;
receiving the angler's query at the server via the communications network; and
when the desired tackle item is present in the inventory, provide, to the display of the angler's computing device, a geographic location of one or more of the plurality of tackle vending machines containing the desired tackle item.

7. The system of claim 5, further comprising:
provide, to the display of the angler's computing device, a browser user interface configured to permit the angler to browse the inventory of the one or more of the plurality of tackle vending machines.

8. The system of claim 7, further comprising:
receiving, at the server, a tackle selection from the inventory.

9. The system of claim 8, further comprising:
receiving, at the server, a payment for the tackle selection.

10. The system of claim 9, further comprising:
communicating to a designated tackle vending an angler purchase of the tackle selection; and
dispensing the tackle selection to the angler, via a dispensing module.
